(19) United States
(12) Patent Application Publication
(10) Pub. No.: US 2013/0111006 A1
(43) Pub. Date: May 2, 2013

(54) REAL TIME ENTERPRISE INFORMATION SYSTEM FOR SYMBIOTIC COMPUTING

(71) Applicant: Albert Cecchini, Jamestown, NY (US)

(72) Inventor: Albert Cecchini, Jamestown, NY (US)

(21) Appl. No.: 13/283,058

(22) Filed: Oct. 27, 2011

(51) Int. Cl. G06F 15/173

(52) U.S. Cl. 709/224

(57) ABSTRACT

An adaptive enterprise information system (AEIS™) for a distributed computing system that monitors a plurality of concurrent adaptive web system (AWS) sessions. The AEIS™ obtains information from the monitored AWS sessions as well as from external systems. For one embodiment, the AEIS™ obtains the information continuously on a periodic basis; in an alternative embodiment the AEIS™ obtains the information upon request. Using the obtained information, the AEIS™ determines whether changes are required to any of the concurrent AWS sessions and makes the required changes in real time during the AWS sessions. The AEIS™ makes the required changes automatically, without a request from the user.

### CROSS REFERENCE TO RELATED APPLICATIONS

This application is a non-provisional application that claims the priority of U.S. Provisional Patent application No. ______ entitled “An Adaptive Enterprise Information System for Symbiotic Computing,” filed on Oct. 28, 2010, the teachings of which are incorporated by reference herein.

### TECHNICAL FIELD

Embodiments of the invention relate generally to the field of distributed computing systems and more specifically to symbiotic computing systems.

### BACKGROUND

Symbiotic computing differs from conventional distributed computing in that a symbiotic computing system adapts to system configuration changes, changed parameters, new environments, and new types of users without a user's explicit direction. A traditional distributed system is not allowed to make such adjustments without user direction, typically by an administrator explicitly directing the adjustments. In the Eighth IEEE Internal Conference on Cognitive Informatics (2009), Takahide Maemura, Shigeru Fujita, and Tetsuo Kinoshita presented a paper titled, Flexible Distributed System for Symbiotic Computing (Maemura et. al.). In Maemura et al., the authors describe an adaptive web system (AWS) for symbiotic computing that automatically changes link structure and presentation among its web pages according to differing user properties and accessing situations. The model described in Maemura et al. creates and reconstructs the web pages using web page components and web page meta-descriptions stored in a Page Repository (PR). FIG. 1 illustrates an AWS for symbiotic computing in accordance with such a prior art system.

The AWS shown in FIG. 1 includes the following components: 1) a Request Analysis Function (RAF) that receives and analyses the users' requests to detect the diversification of the users' requirements and properties; 2) a Platform Sensor Function (PSF) that monitors the dynamic characteristics of the platform and the user's accessing situations; 3) a Web Site Re-construction Function (WSRF) that re-designs the organization of the web site and web pages using the components stored in the PR according to the results of the request analysis of the RAF and the acquired situation by PSF; and 4) a Link Re-write Function (LRF) that implements the results of the WSRF and replaces the hyper-links among the modified web pages based on the results of the WSRF.

A conventional AWS is adaptive to the users of the AWS and their individual situations as the AWS session loads or as the user interacts with the AWS session which, in turn, makes a request of the system. A conventional AWS adapts to a diversification of users and users' accessing situations, but does not adapt in real time to multiple concurrent AWS users and external systems. A system is desired that adapts in real time to multiple concurrent AWS users and external systems. The present invention addresses this need in the art.

### SUMMARY

In accordance with a first embodiment of the invention, a distributed computing system is disclosed that includes an adaptive enterprise information system (AEIS™) that monitors a plurality of concurrent adaptive web system (AWS) sessions. The AEIS™ obtains information from the monitored AWS sessions as well as information from external systems. For one embodiment, the AEIS™ obtains the information continuously on a periodic basis; in an alternative embodiment, the AEIS™ obtains the information upon request. Using the obtained information, the AEIS™ determines whether changes are required to any of the concurrent AWS sessions and makes the required changes in real time during the AWS sessions. The AEIS™ makes the required changes automatically, without a request from the user.

Embodiments of the invention adapt to multiple diverse users and their particular accessing situations as well multiple diverse external systems and their situations. This allows AWS sessions to be affected by concurrent AWS sessions and external systems in real time during the AWS session. Moreover, the AEIS™ effects changes to AWS sessions automatically without interaction or request from the user. Therefore, a current AWS session may be changed during the session based upon activities occurring elsewhere in the AEIS™. Such changes are determined by the AEIS™ and sent to the AWS session as required. In one embodiment, the AEIS™ effects changes by sending a refresh command to at least one AWS session.

Other features and advantages of embodiments of the present invention will be apparent from the accompanying drawings, and from the accompanying detailed description, that follows below.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 illustrates an AWS for symbiotic computing in accordance with the prior art;

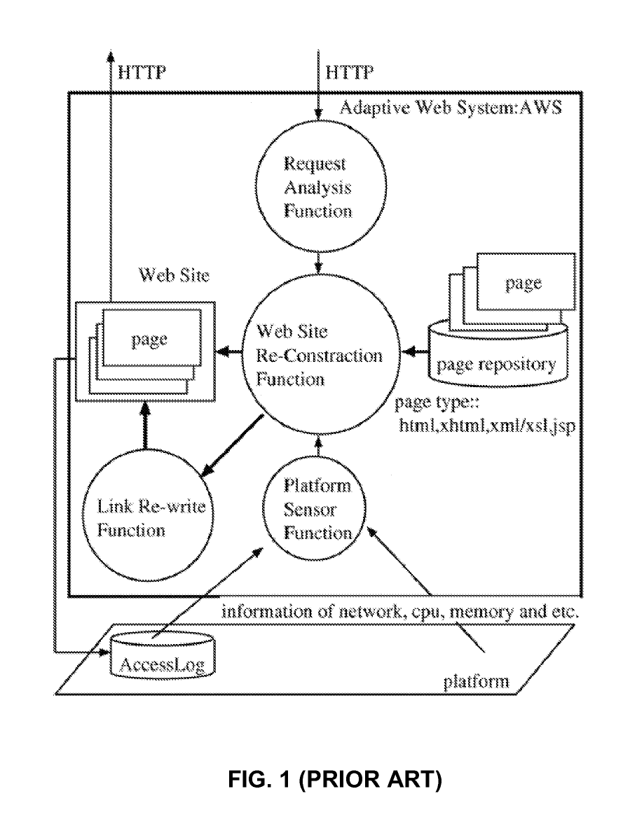

FIG. 2 illustrates a symbiotic computing system in accordance with one embodiment of the invention;

FIG. 3 illustrates an exemplary computing system implementing an AEIS™ in accordance with one embodiment of the invention;

FIG. 4 illustrates an AEIS™ in accordance with one embodiment of the invention;

FIG. 5 illustrates the components of an embodiment of a network that supports an AEIS™ in accordance with one embodiment of the invention;

FIG. 6 illustrates a collaboration diagram of a network that supports an AEIS™ in accordance with one embodiment of the invention; and

FIG. 7 illustrates a sequence diagram of a network that supports an AEIS™ in accordance with one embodiment of the invention.

### DETAILED DESCRIPTION OF ILLUSTRATIVE EMBODIMENTS

A system for symbiotic computing in accordance with a first embodiment includes an adaptive enterprise information system (AEIS™) that monitors a plurality of concurrent adaptive web system (AWS) sessions, obtains information from the monitored AWS sessions and from external systems, uses the information obtained to determine changes to one or more of the concurrent AWS sessions, and effects the determined changes in real time during the AWS sessions without a request from a user.

In the following description, numerous specific details are set forth. However, it is understood that embodiments of the invention may be practiced without these specific details. In other instances, well-known architectures, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable in a variety of settings in which symbiotic computing systems are deployed, referenced, or used.

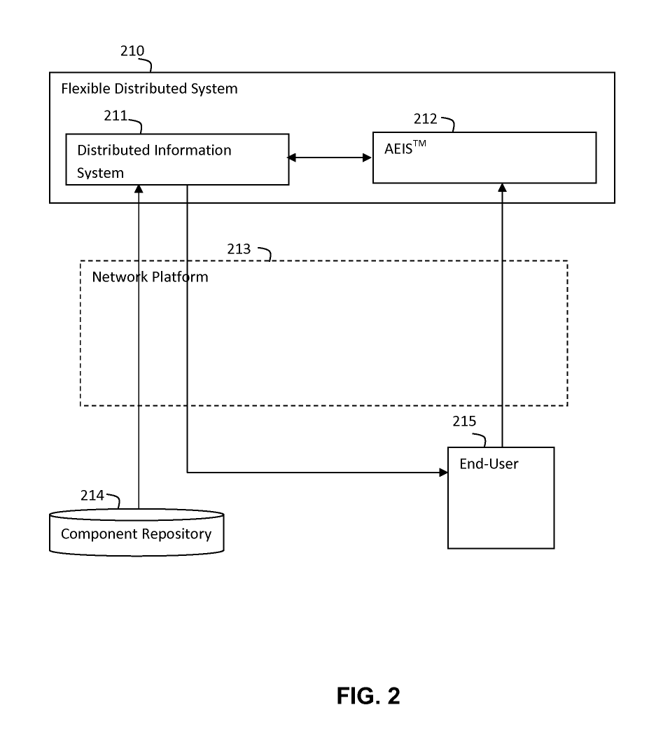

FIG. 2 illustrates a symbiotic computing system in accordance with one embodiment of the invention. As shown in FIG. 2, the system includes a flexible distributed system 210 having a distributed information system 211 communicatively coupled to an AEIS™ 212. A component repository 214 communicates with the distributed information system 211 via a network platform 213. The distributed information system 211 also communicates with multiple end-users shown, for example, as end-user 215 via the network platform 213. End-users 215 may be any system users including an administrator or a developer of the AEIS™. The distributed information system 211 and the AEIS™ 212 communicate with end-user 215 via the network platform 213 and may also communicate with external systems or other enterprise information systems, not shown.

For various embodiments of the invention, the AEIS™ 212 is supported by the flexible distributed system 210. The flexible distributed system 210 includes a distributed processing system (e.g. an n-tier software architecture) data retrieval, rights management, business rules, databases, work flow, and the like; and contains an interface to the AEIS™ 212 that manages the communication between the AEIS™ 212, end-users 215 and any external systems interacting with the AEIS™ 212. The AEIS™ 212 may communicate with the flexible distributed system 210 to obtain information continuously, on a periodic basis, or upon request.

For one embodiment of the invention, the AEIS™ 212 provides the following functionality. The AEIS™ 212 monitors and stores information as to which user is in which of multiple concurrent AWS sessions. That is, the AEIS™ 212 identifies a particular AWS session with a particular end-user 215. The AEIS™ 212 monitors and records all AWS and external system changes as they are made and references business rules for each AWS session. The referenced business rules may be in regard to many aspects of the AWS including, for example, the presentation and content of forms as well as the link structure. The AEIS™ 212 analyzes the business rules for each of multiple concurrently active AWS sessions, and/or external system interaction, to determine their effect on any other of the multiple concurrently active AWS sessions. The AEIS™ 212 determines required changes based upon the analysis and pushes the required changes to the appropriate AWS user session, automatically, without request from the end-user 215.

Through the communication interface with the flexible distributed system 210, the AEIS™ 212 constantly receives information. The AEIS™ 212 also requests information from the multiple concurrent AWS sessions and external systems. As a result of receiving such information, the AEIS™ 212 sends commands either directly or through the flexible distributed system 210 communication interface to effect change in the active AWS sessions.

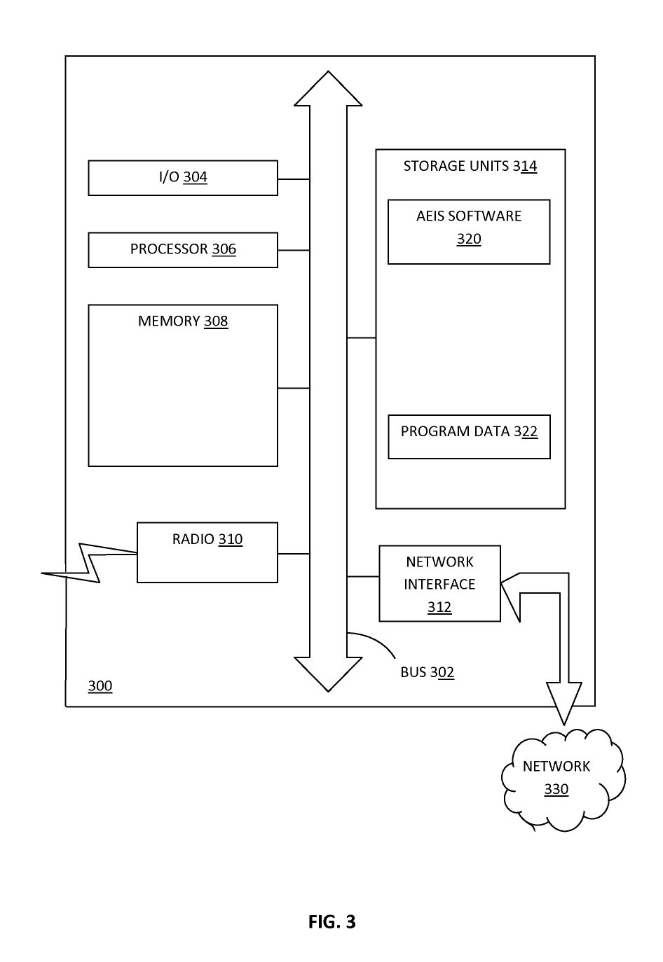

FIG. 3 illustrates an exemplary computing system implementing an AEIS™ 212 in accordance with one embodiment of the invention. The computer 300 includes a processor 306 in communication with a computer readable storage medium, where the computer readable storage medium is any medium that that stores information for retrieval later by the processor 306. For example, in the illustrated embodiment, computer readable storage medium includes memory 308 and data storage units 314. Memory 308 is possibly a fast-access memory and is used to run program instructions executable by the processor 306. Memory 308 is also possibly random access memory (RAM), read only memory (ROM), and/or flash memory. Data storage units 314 are possibly physical devices and are used to store any data and instructions which may be accessed by the processor 306, such as program data 322 and instructions for the software that facilitates an embodiment of an AEIS™ 320. Data storage units 314 are possibly an optical medium, a magnetic medium such as a floppy disk, a compact disc (CD), a digital video disk (DVD), and/or a solid-state medium such as RAM, ROM, and flash memory.

The computer 300 operates in a networked environment using logical connections to communicate with other computers and communication devices. The computer 300 and other computers and communication devices are possibly a personal computer, a server, a router, a network PC, a peer device, or other types of network nodes. When used in a LAN or WLAN networking environment, the computer 300 is connected to other computers and communication devices via the LAN or WLAN through a network interface 312. The computer 300 also may include a radio 310 for wirelessly transmitting and receiving data.

To provide input/output to and from the elements of the computer system, the computer 300 has input/output devices 304, a bus 302, and other circuitry that facilitates coupling between the input/out devices 304 and other elements of the computer system 300.

The above-mentioned software and electrical components of the computer system 300 are made of computer hardware, software, firmware, or any combination thereof. The communications between such software and electrical components occur in the form of signals including electronic signals, electromagnetic signals, optical signals, or any combination thereof.

Where software is used to implement the AEIS™ 320, it is preferred to use platforms or frameworks such as .NET, J2EE, open source technologies, or any combination thereof. In this disclosure, a number of the elements of the AEIS™ 320 are illustrated using .NET technologies; however, comparative technologies may substitute or combine with the .NET technologies. For example, JSP or PHP are alternative technologies to ASP.NET where the AEIS™ 320 is implemented using J2EE or open source technologies. Where a software framework is used, software framework components may include: a common data access interface; a data access tier, which allows simultaneous access to multiple databases and database platforms (e.g. ADO.NET, ODBC, etc. . . . ); a data merge (e.g. data merge using XML); an interpreter tier (e.g. an interface using XML); a user interface creation tier; and a presentation tier including at least one thin client. Preferably, the thin client is a web thin client (or an ultra-thin client) which includes API calls to the middleware of the AEIS™ 320. Where the thin client is a web thin client, it is preferred that the AEIS™ 320 is primarily XML-driven, using XML based templates and XML based business rules.

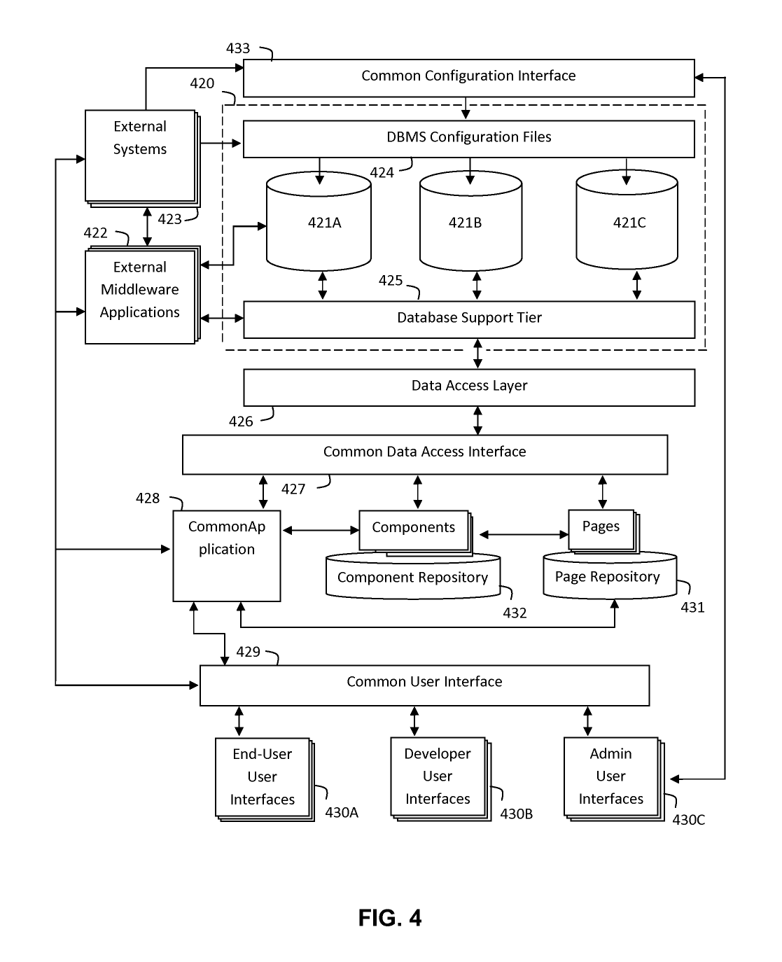

FIG. 4 illustrates an AEIS™ 320 in accordance with one embodiment of the invention. The elements inside the dashed box 420 represent either a data model tier of the AEIS™ 320, a data model tier of an external system, or a combination of the two. The boundary of the data model tier is a dashed line, because the components that it includes vary greatly with different implementations of the overall system (the overall system being a combination of the AEIS™ 320 and external systems). The remaining elements outside the dashed box are elements that typically provide for symbiotic computing, where the AEIS™ elements 426, 427, 428, 429, 430A, 430B, 430C, 431, 432 & 433 can adapt to changes in external system elements 422 & 423 and vice versa. Additionally, both the AEIS™ 320 and external systems 422 & 423 benefit from each other, which is a key factor to the overall system being symbiotic.

In FIG. 4, the common user interface 429, the common configuration interface 433, and the common data access interface 427 provide an interface to the AEIS™ 320 allowing the AEIS™ 320 to interact with a diversity of systems and users in a symbiotic manner. Typically, these interfaces 427, 429, & 433 and the common application 428 solely or in combination provide the flexibility mechanism.

In an embodiment of the AEIS™ 320, the symbiotic relationship between the AEIS™ 320 and external systems 422 & 423 are facilitated by a bi-lateral intelligent interface tier. The bi-lateral intelligent interface tier includes: a RAF; a response function; a PSF; and various software framework components, where each component is an independent computer program. Preferably, the RAF, the response function, and the PSF are part of the common configuration interface 433, the common data access interface 427, the common application 428, and/or the common user interface 429.

The common user interface 429 specifically facilitates universal user access to the overall system, including access to regular end users, system administrators, and developers interfacing to the AEIS™ 320 from various platforms. The framework further includes user interfaces for end-users, developers, and administrators 430A, 430B, & 430C that communicated directly with the common user interface 429. Additionally, user interfaces 430A, 430B, & 430C that are or are not a part of the AEIS™ 320 may communicate directly or indirectly, via an external middleware application 422, with the common user interface 429.

The common configuration interface 433 facilitates universal database configuration by providing a communication interface with database management system configuration files 424. The common configuration interface 433 also communicates with the administrator user interfaces 430C. In other implementations of the AEIS™ 320, the common configuration interface 433 communicates with interfaces of external systems 422 & 423, especially interfaces used by developers 430B.

The common data access interface 427 facilitates universal database access and database platform compatibility by being an interface between elements of the AEIS™ 320 and a data access layer 426 of the AEIS™ 320. The data access layer 426 communicates directly with a database support tier 425 of either the AEIS™ 320 or other external systems 422 & 423. As shown in FIG. 4, the database support tier 425 communicates with databases 421A, 421B, & 421C and middleware applications 422 external to the AEIS™ 320 that in-turn communicate with external computer information systems 423. Additionally the middleware 422 of the AEIS™ 320 and the external systems 422 may communicate directly, bypassing the data model tier 420, or indirectly, via the data model tier 420.

The common application 428 acts as middleware or control for facilitating the above-mentioned interfaces and other elements of the AEIS™ 320 and the external systems 422 & 423. Specifically, the common application 428 acts as such by interacting with the common data access interface 427, the common user interface 429, components of a component repository 432, and with views, windows, or web pages of a page repository 431. Alternatively, the components, pages, windows, and views communicate directly with the common data access interface 427.

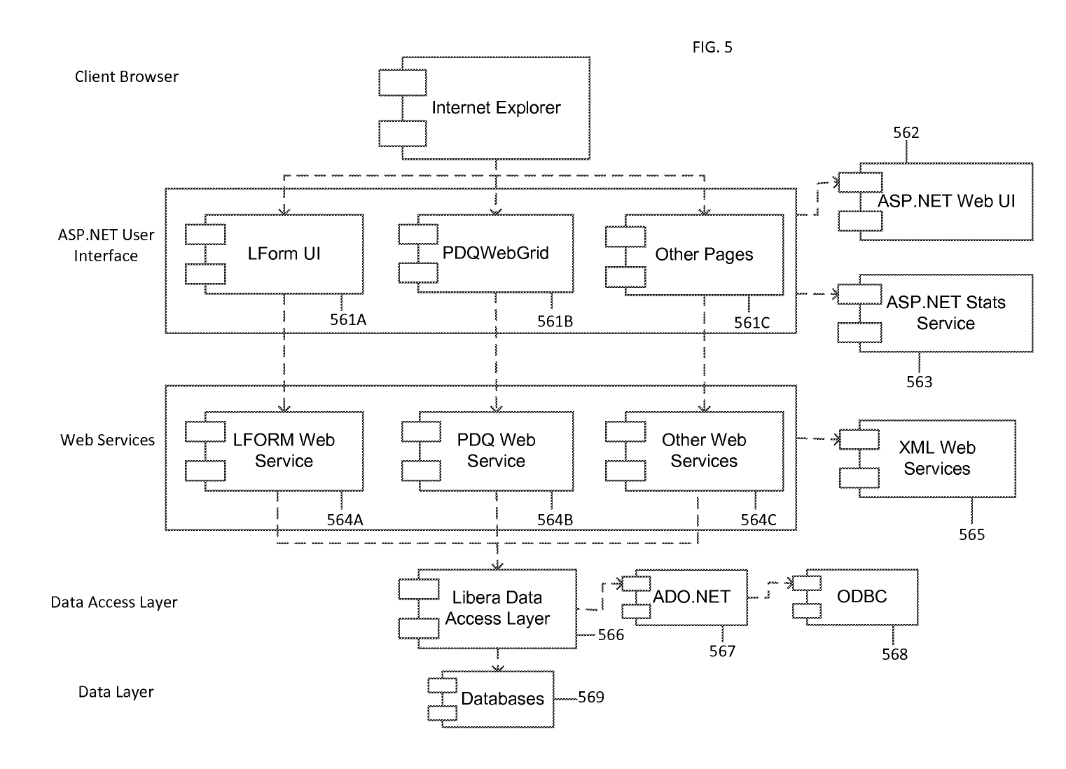

FIG. 5 illustrates the components of an embodiment of a network that supports an AEIS™ 320 in accordance with an embodiment of the invention. FIG. 5 includes five levels: a client browser (e.g. Internet Explorer); a programmable user interface (e.g. ASP.NET, JSP, PHP, etc. . . . ); communication services (e.g. web services); a data access layer; and a data layer. The programmable user interface includes multiple dynamic web page interfaces 561A, 561B, & 561C, and the user interface communicates with a web specific user interface 562 and a state service 563. Where the communication services are web services, various services 564A, 564B, & 564C communicate with XML web services 565. The web services 565 may include LFORM web services and PDQ web services. The data access layer includes a proprietary data access layer 566 that communicates with a data access platform (e.g. ADO.NET) 567 that in turn communicates with ODBC 568. The data layer typically consists of databases 569. The proprietary data access layer 566 communicates with the databases 569 and incorporates the data access platforms 567 & 568. For the most part, the programmable user interface, communication services, and the proprietary data access layer 566 solely or in combination provide the flexibility mechanism; however, in other embodiments, the flexibility mechanism may be provided by other elements of the AEIS™ 320 solely or in combination.

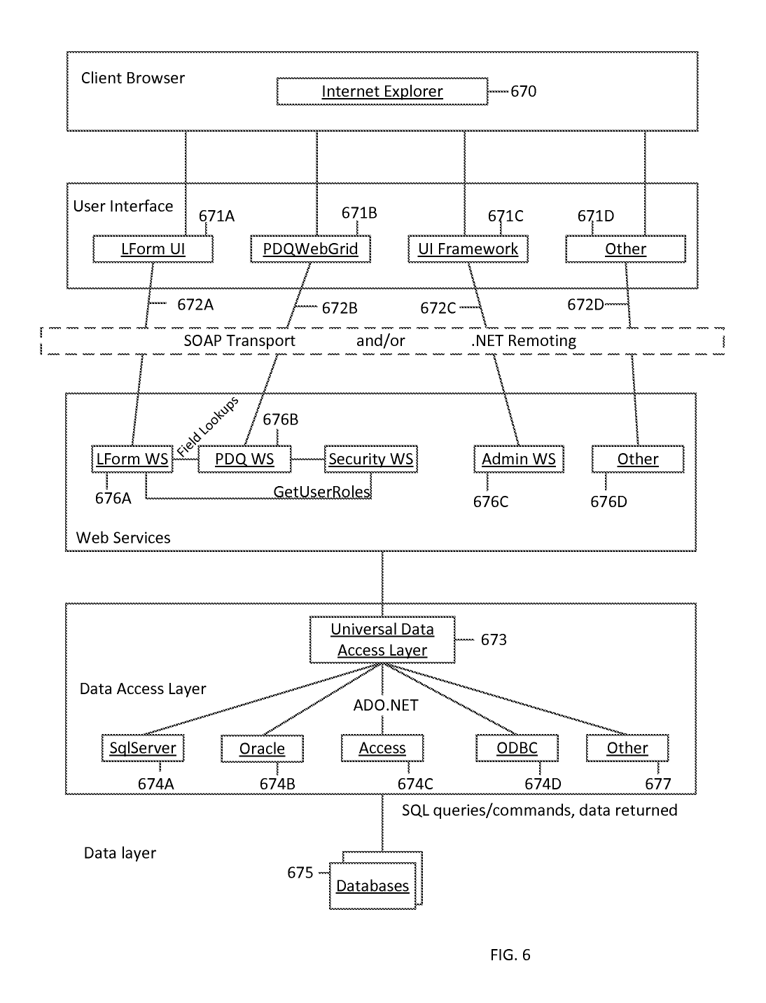

FIG. 6 is a collaboration diagram of a network that supports an AEIS™ 320 in accordance with one embodiment of the invention. FIG. 6 includes: a client browser (e.g. Internet Explorer 670); a programmable user interface (e.g. ASP.NET, JSP, PHP, etc. . . . ); communication services (e.g. web services); a data access layer; and a data layer. The programmable user interface includes multiple dynamic web page interfaces 671A, 671B, 671C, & 671D. Each multiple dynamic web page interface makes Simple Object Access Protocol (SOAP) method requests 672A, 672B, 672C, & 672D communicating with field lookups 676A, 676B, 676C, & 676D via SOAP transport and/or a remote communication service (e.g. .NET Remoting). The communication services communicates with a universal data access layer 673 that communicates with various relational database management systems (RDBMS) 674A, 674B, 674C, 674D & 674E that communicate with databases 675. For the most part, the programmable user interface, communication services, and universal data access layer 673 solely or in combination provide the flexibility mechanism; however, in other embodiments, the flexibility mechanism may be provided by other elements of the AEIS™ 320 solely or in combination. Specifically, and for the majority of embodiments, the dynamic web page interfaces 671A, 671B, 671C, & 671D provide the flexibility mechanism of the programmable user interface.

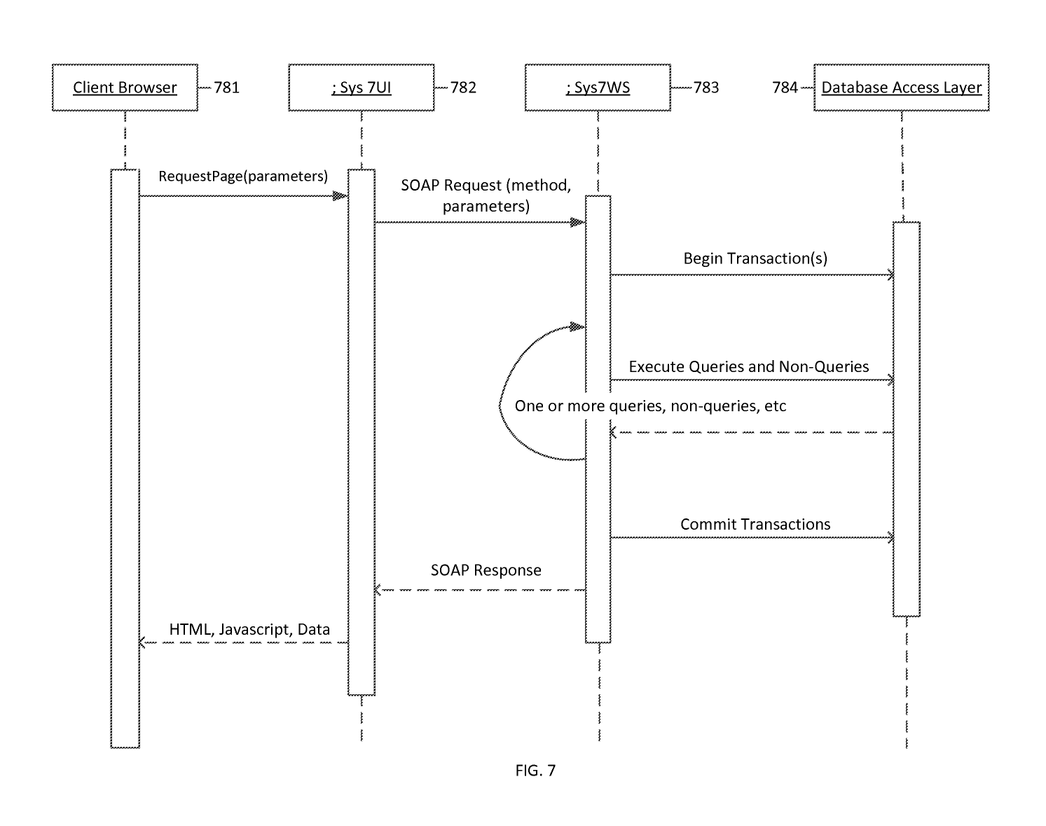

FIG. 7 is a sequence diagram of a network that supports an AEIS™ 320 in accordance with one embodiment of the invention. FIG. 7 includes a client browser 781, a user interface application 782, a web services application 783, and a database access layer 784. First, the client browser 781 makes a page request to the user interface (UI) application 782. Next, the UI application 782 makes a SOAP request to the web services (WS) application 783, calling a method of the WS application 783 with parameters. The method of the WS application begins a transaction(s) with the database access layer 784, executes queries and non-queries, and then the database access layer after communicating with a database returns data to the WS application. Then the data is checked by the WS application 783 and then the transactions are committed. Finally, the WS application 783 sends a SOAP response to the UI application 782 that in turn sends HTML, JavaScript, and data to the client browser 781 that renders a view to the end-user.

Though various embodiments of the present invention have been described above, it should be understood that embodiments have been presented by way of example, and not limitation. A person of ordinary skill in the art will recognize that there are various changes that can be made to the present invention without departing from the spirit and scope of the present invention. Therefore, the invention should not be limited by any of the above-described example embodiments, but should be defined only in accordance with the following claims and equivalents of the claimed invention.

Embodiments of the invention have been described as including various operations. Many of the processes are described in their most basic form, but operations can be added to or deleted from any of the processes without departing from the scope of the invention. For example, for various alternative embodiments, the AEIS™ may be controlled through a configuration interface. The configuration interface may be implemented as an external interface that communicates with the computing system and the AEIS™, or may be implemented peripherally within the computing system, or integrated with the AEIS™. For embodiments that implement a configuration interface, a user may select or modify parameters of the AEIS™ without resorting to recoding. Many parameters of the AEIS™ may be selected or modified via a user interface. For example, a user may select or change the time interval at which the AEIS™ communicates with a processing system. The user may also specify which AWS sessions will be monitored by the AEIS™. The user may also specify which business rules are implemented or considered in determining changes to an AWS. Other parameters of the AEIS™ may be selected or changed via a user interface.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central site or, alternatively, one or more operations may be performed elsewhere.

What is claimed:

1. A symbiotic computing system that facilitates communications between a component repository and a user interface, comprising:
a distributed processing system including an adaptive enterprise information system (AEIS™) configured to:
monitor a plurality of concurrent adaptive web system (AWS) sessions,
obtain information from one or more of the plurality of concurrent AWS sessions and one or more external systems,
determine changes to at least one of the plurality of concurrent AWS sessions based upon the obtained information, and
effect changes to at least one AWS session of the plurality of concurrent AWS sessions during the at least one AWS session; and
a network that facilitates secure communication between the component repository, the distributed processing system, and the user interface.

2. The symbiotic computing system of claim 1 wherein the AEIS™ effects changes by sending a refresh command to the at least one AWS session.

3. The symbiotic computing system of claim 1 wherein the AEIS™ determines changes by determining whether one or more business rules have been violated.

4. The symbiotic computing system of claim 1 wherein the AEIS™ determines changes by determining a requirement to enact a business rule.

5. The symbiotic computing system of claim 1 wherein the AEIS™ communicates with the distributed processing system continuously at predetermined intervals.

6. The symbiotic computing system of claim 1 wherein one or more parameters of the AEIS™ are selected via a user interface.

7. The symbiotic computing system of claim 6 wherein the one or more parameters of the AEIS™ include a time interval at which the AEIS™ communicates with a processing system, a selected plurality of AWS sessions to be monitored by the AEIS™, and one or more business rules to be implemented or considered in a determination of changes to an AWS.

8. The symbiotic computing system of claim 1 wherein the distributed processing system comprises a web-based processing system.

9. The symbiotic computing system of claim 1 wherein the distributed processing system processes a case management system.

10. A method of facilitating communications between a component repository and a user interface, comprising:
monitoring a plurality of concurrent adaptive web system (AWS) sessions of a distributed processing system;
obtaining information from one or more of the plurality of concurrent AWS sessions and one or more external systems;
determining changes to at least one of the plurality of concurrent AWS sessions based upon the obtained information; and
effecting changes to at least one AWS session of the plurality of concurrent AWS sessions during the at least one AWS session.

11. The method of claim 10 wherein the changes are effected by sending a refresh command to the at least one AWS session.

12. The method of claim 10 wherein the changes are determined by determining whether one or more business rules have been violated.

13. The method of claim 10 wherein the changes are determined by determining a requirement to enact a business rule.

14. The method of claim 10 wherein the operations of monitoring a plurality of concurrent AWS sessions, obtaining information from one or more of the plurality of concurrent AWS sessions and one or more external systems, determining changes to at least one of the plurality of concurrent AWS sessions based upon the obtained information; and effecting changes to at least one AWS session of the plurality of concurrent AWS sessions during the at least one AWS session are performed continuously at predetermined intervals.

15. The method of claim 10 wherein the operations of monitoring a plurality of concurrent AWS sessions, obtaining information from one or more of the plurality of concurrent AWS sessions and one or more external systems, determining changes to at least one of the plurality of concurrent AWS sessions based upon the obtained information; and effecting changes to at least one AWS session of the plurality of concurrent AWS sessions during the at least one AWS session are effected by an AEIS™ and one or more parameters of the AEIS™ are selected via said user interface.

16. The method of claim 15 wherein the one or more parameters of the AEIS™ include a time interval at which the AEIS™ communicates with a processing system, a selected plurality of AWS sessions to be monitored by the AEIS™, and one or more business rules to be implemented or considered in a determination of changes to an AWS.

17. The method of claim 10 wherein the distributed processing system comprises a web-based processing system.

18. The method of claim 8 wherein the distributed processing system processes a case management system.
